(19) United States
(12) Patent Application Publication
(10) Pub. No.: US 2010/0236729 A1
(43) Pub. Date: Sep. 23, 2010

(54) TOR II

(75) Inventor: Jörg Fischer, Dortmund (DE)

Correspondence Address: Schwabe Williamson & Wyatt;PACWEST CENTER, SUITE 1900, 1211 SW FIFTH AVENUE, PORTLAND, OR, 97204, US

(73) Assignee: SEUSTER KG, Ludenscheid (DE)

(21) Appl. No.: 12/725,358

(22) Filed: Mar. 16, 2010

(30) Foreign Application Priority Data
Mar. 17, 2009 (DE) 10 2009 013 550.2
Mar. 17, 2009 (DE) 10 2009 013 754.8

(51) Int. Cl. E06B 9/60; E05F 15/00; E05F 15/18; E06B 9/56; G05B 11/01

(52) U.S. Cl. 160/318; 49/360; 160/309; 700/275

(57) ABSTRACT

The invention concerns a gate with a section that is movable, along a preferably prescribed track that features a, for the most part, rectilinear running section, between a closed position and an open position, a controller that is designed for the purposes of controlling the gate section movement and for the generation of first control signals for preferably the purpose of stopping the gate section movement in the event of leaving the prescribed track, whereby associated with the controller is a transmitter arrangement for the purposes of generating two, three or more signals that run along approximately perpendicular to the prescribed track and approximately parallel to a, during the closing movement, preceding edge of the gate section as well as spread on sequentially arranged signal paths, in the direction of the gate section movement, whereby the signal paths during the course of the closing movement are chronologically sequentially interrupted and/or during the course of the opening movement are chronologically sequentially released, particularly by the gate section's edge that precedes during the closing movement.

The invention concerns a gate with a gate section that is movable, along a preferably prescribed track that features a, for the most part, rectilinear running section, between a closed position and an open position and a controller that is operable for the purposes of controlling the gate section movement for the generation of first control signals for the purpose of stopping the gate section movement in the event of leaving the prescribed track, and is designed for the generation of second control signals, preferably during the course of an interruption, of at least one signal path, that was not caused by the gate section movement, wherein in response to the second control signal a reversal of the gate section movement is triggerable as well as a procedure for monitoring the closing movement of a gate section of a gate of such a kind.

Gates of the kind described above are utilized for example in factory buildings for partitioning of different manufacturing areas, as a close-off of spaces or in the form of garage- or industrial gates. In this context the gate sections of so-called sectional gates can feature a plurality of flexibly connected gate section elements that are disposed in the closed position approximately in the vertical plane and in the open position overhead approximately in the horizontal plane. Particularly in the context of the partitioning of different manufacturing areas in production buildings so-called strip curtain gates are utilized, for which the gate section is shaped in form of a pliable track-shaped curtain that is disposed, in the closed position, approximately in the vertical plane and is wound up on a winding shaft in the open position above or behind the lintel of the opening that is to be closed. Furthermore such gates are also utilized where the gate section consists of flexibly connected lemellas that are also wound up into a multi-layered wrap in the closed position. In the case of the gate types described last the prescribed track runs approximately in the direction of gravity so that the gate section's edge, which precedes during the closing movement, abuts in the closed position to the floor of the opening that is to be closed by the gate section

In order to avoid accidents involving persons and property damage measures have to be taken in the context of the described gates by means of which the gate section movement can be stopped as soon as a person and/or an object enters the area of the prescribed track. In this context the use of for example so-called contact rails on the gate section's edge that precedes during the closing movement and the use of light barrier arrangements have become known. Corresponding gates are, for example, described in DE 20 2007 003 199.

As appropriately described in the mentioned publication one has to consider the case, especially during the operation of roll gates or strip curtain gates, where the gate section exits the prescribed track, such as for example due to the impact of a fork lift or similar. In this case the movement of the gate section has to be immediately stopped in order to avoid additional damages. For this purpose the utilization of switches is proposed in the mentioned publication, by means of which the impact of a vehicle or similar onto the gate section is established and a corresponding interrupt signal or control signal is generated. It has however been shown that the exit from the prescribed track cannot be reliably established through the use of corresponding switches.

In view of these problems in the state of the art it is the object of the invention to provide gates, during the operation of which damages due to the impact of vehicles and such during the closing movement can be minimized, and corresponding monitoring processes.

According to the invention this problem is solved by means of a further improvement of the known gates, characterized primarily in that associated with the controller is a transmitter arrangement for the purposes of generating two, three or more signals that run along approximately perpendicular to the prescribed track and approximately parallel to a, during the closing movement, preceding edge of the gate section as well as spread on sequentially arranged signal paths, in the direction of the gate section movement, whereby the signal paths during the course of the closing movement are chronologically sequentially interrupted and/or during the course of the opening movement are chronologically sequentially released, particularly by the gate section's edge that precedes during the closing movement.

This invention is based on the realization that the exit from the prescribed track can be established by means of the utilization of, as such, known light gates by means of the analysis of the chronological sequence of the interruption or release of the individual signal paths. Additional mechanical switches, which are correspondingly prone to interference, are not required for that purpose. Therefore an improvement of the operational reliability of the known gates can be achieved by means of the proposed improvement according to the invention, particularly in the context of the detection of the exit from the prescribed track. In order to avoid additional damages the gate section movement is, responding to the first control signal, preferably stopped immediately so that a controlled return of the gate section to the prescribed track can commence. For the analysis of the chronological sequence of the interruption of the signal paths the controller of a gate according to the invention features suitably an analysis circuit for the analysis of the chronological sequence of the interruption of the signal paths during the process of the gate section closing movement and for the generation of the first control signals in the event of a deviation of the chronological sequence from a prescribed chronological sequence. The analysis circuit can be implemented particularly simple, if it is designed for the generation of control signals, as soon as the chronological distance between the interruption of sequentially following signal paths exceeds a prescribed chronological distance.

Within the scope of the invention it has proven to be advantageous if the deployed light gate according to the invention can fulfill two functions, by means of which not only the exit from the prescribed track, corresponding to the impact of a vehicle onto the gate section, but also the intrusion of persons or objects into the area of the prescribed track can be determined. For this purpose the controller of gates according to the invention is suitably designed for the generation of second control signals in the case of an interruption of at least one signal path that was not triggered by the movement of a gate section, whereby preferably in response to the second control signal a reversal of the gate section movement is triggerable in order to thereby eliminate a contact, which possibly has already occurred, between the gate section and the object or the person. In the case of gates according to the invention a prescribed chronological sequence of the interruption of the signal paths is commonly stored. In the process an interruption of at least one signal path that was not initiated by the gate section movement can be detected if this interrupted signal path is disposed along the prescribed track in the closing direction behind a signal path that has not yet been interrupted by the gate section movement. Such an interruption then can only be caused by an object or a person that entered into the prescribed path.

The transmitter arrangement of a gate according to the invention can be implemented particularly simple if it features at least one light source, such as an LED or a diode laser. For verification of the interruption of a signal path a receiver arrangement is suitably provided that is disposed for the purpose of receiving the signals that are spreading along the signal paths, and preferably features at least one photocell, such as for example a photodiode, by means of said receiver arrangement, in response to the arrival of the signals that are spreading along the signal paths, corresponding reception signals can be generated and be applied to the controller. The transmitter arrangement and/or the receiver arrangement is suitably installed in the area of the edge of the opening that is to be closed with gate section, said edge preferably extends approximately parallel to the prescribed track, whereby the receiver arrangement is preferably installed in the area of the edge of the opening that faces the edge featuring the transmitter arrangement.

In the context of gates according to the invention, in reference to the aim of increased operational reliability, a guide implementation is provided, preferably at least one disposed on the lateral edge of the opening to be closed with the gate section, approximately extending parallel to the prescribed track, especially in the direction of gravity, and in the closed position overlapping at least one lateral edge of the gate section in a horizontal cutting plane, for the purpose of guiding the gate movement. In this case the transmitter arrangement and/or the receiver arrangement can be protected from damages in order to thereby further increase the operational reliability, if the transmitter arrangement and/or the receiver arrangement are disposed within the guide implementation. The guiding implementation can thereby be implemented essentially U-shaped with a connecting leg, and a side limb that can extend from the lateral edges of the connecting leg in the direction of the space to be closed by the gate section, whereby a lateral edge of the gate section is encompassed, in the closed position, between the side limbs. For example brush-shaped sealing assemblies that abut to the gate section in the closed position can be attached to the edges of the side limbs that are facing away from the connecting leg. A particularly reliable protection of the transmitter arrangement and/or receiver arrangement provided according to the invention can be achieved if this transmitter arrangement and/or receiver arrangement is attached to a boundary surface, of the connecting leg, that is facing the opening because this location within the guiding implementation is the furthest removed from the opening of the guiding implementation that permits the entrance of dirt and/or moisture into the guiding implementation and serves the purpose of receiving the lateral gate section edge.

The invention is, as was explained initially, deployable with a particular advantage if the gate section is windable onto a winding shaft during the course of the opening movement and preferably is implemented as a pliable track-shaped curtain, whereby on the, during a closing movement, preceding edge of the track-shaped curtain a, preferably elastically deformable, stabilizing assembly is attached that counteracts the deformation of this edge, whereby the reset force of the stabilizing assembly that counters the deformation in the closing direction is less than the reset force that counters a deformation in an oblique direction thereto, and the stabilizing assembly features preferably at least one leaf spring, preferably embedded in an elastomeric material, with main surfaces aligned obliquely to the closing direction.

In the context of the embodiment examples of the invention described so far the first control signal as well as also the second control signal are generated by means of the monitoring of the signals that spread parallel to the gate section's edge, which precedes during a closing movement, and along sequentially arranged signal paths in the direction of the gate section movement. The light gates that are also deployed for the generation of the first control signals in these embodiment forms extend usually only up to a height of about 2,500 mm while the protective function achieved by means of the first control signal are also needed for taller gates.

To this end the height of the light gates could be increased. This however involves a significantly increased effort. According to a second provided embodiment of the invention that is additional or alternative to the first embodiment of the invention a signal is provided that spreads in parallel, in particular vertically, along the linearly running section of the prescribed track, whereby the signal path, during trouble-free operation, is interrupted by the preceding edge of the gate section during the closing movement, so that an impact onto the gate section and the therewith associated exit from the prescribed track can be established by means of the corresponding signals or the verification of this signal. The corresponding light source and/or verification arrangement can be installed in a protected manner within the guiding implementation.

The light source can be a throw-away infrared light gate, a reflector light gate, a laser or similar. It is of significance that by means of the analysis of the signals that originate from this light source the change of the gate section's (lower part) edge, which precedes during the closing movement, is conclusively and reliably detected and oscillations of the lower part caused by the movement or by the wind do not lead to malfunctions. For the conclusive detection of the exit of the prescribed track, for example because of the impact of a vehicle, it useful to install a light source at each of the two installed vertical guiding implementations of the sides, which face one another, of the opening that is to be closed with the gate sections.

For a limited protection (cost saving) the light source that is intended for the generation of a signal that spreads parallel to the prescribed track can also be installed only on one side of the gate section. As soon as the gate section's lower edge, which precedes during the closing movement, exits the prescribed track the signal that is spreading along the prescribed track changes and the gate is, in response to the trigger of the first control signal, stopped.

In the event of an impact of a person or of an object first as well as also second control signals can be triggered. If it concerns only a light contact as a result of which the gate section does not exit the prescribed track, only the second control signals are triggered and a reversal of the gate section movement is triggered in response to the second control signals. If the edge (lower part) that precedes during the closing movement exits the prescribed track as a result of an impact, first control signals as well as also second control signals are triggered. In this case the gate section movement is stopped in order to avoid damages to the gate, meaning that the first control signals overlay the second control signals.

As a particular advantage of gates according to the invention it should be emphasized that on the movable closing edge no electrical components such as contact rails, crash switches, wireless transmission systems or similar are installed, as all components required for the triggering of the control signals (light sources, verification installations) are attached to permanently installed construction components (lateral sections). The system is therefore very robust regarding moisture, loading due to wind, temperature and wear and tear, which makes gates according to the invention appear, in comparison to conventional gates with spiral cables or battery-powered wireless systems, to have an advantage.

Within the context of the invention it has also been considered to realize all of the signals, which spread parallel to the edge that precedes during the closing movement as well as also parallel to the prescribed track, by means of signal sources within one construction component. Thereby a compact construction with only one signal transmission is created. The signal transmission can generally be realized by means of a permanently installed cable. The possibility also exists to implement the connection wirelessly.

In order to increase the functional reliability of gates according to the invention the first control signal can be generated additionally or alternatively in response to an activation of at least one mechanical switch, particularly a snap switch, that is attached to at least one gate section's edge that runs parallel to the prescribed track and/or in the area of a lateral edge, of the opening that is to be closed by the gate section, that extends approximately parallel to the prescribed track. In the context of this embodiment of the invention the function of the analysis of the signals that spread along signal paths that are approximately parallel to the gate section's edge, which precedes during a closing movement, can remain unchanged. As an additional safety element however a mechanical switch, in particular a snap switch, is installed. Such switches can be attached to both lateral edges of the gate section and/or lateral edges, which extend parallel to the prescribed track, of the opening that is to be closed with the gate section. The snap switches are compressed when the gate section leaves the prescribed track. In response to the compression of the snap switch a radio module can be mechanically activated, by means of which a signal is transmitted to a receiver, in response to which the first control signals can be generated. The receiver for the radio signals can be integrated into a lateral part of the gate. It can also be directly placed in the control that can be operated for the purposes of the generation of the second and/or first control signals.

In the context of this embodiment of the invention it should be mentioned that the electricity usage is lower than the self-discharge of a battery. As a result the radio transmitter can be integrated with a battery into the mechanical switch, particularly a snap switch, whereby the components are can be completely molded in. The radio transmitter in this embodiment form of the invention is only activated when the mechanical switch, particularly a snap switch, is compressed and transmits then a defined signal to the control, which in response to this signal generates the first control signals. Transmitter and receiver are trained to one another at start-up. As a result any number of gates can be operated next to each other.

As can be discerned from the previous explanations of gates according to the invention, a process for the monitoring of the closing movement of a gate section of such a gate, along a prescribed track with said process, during the course of the closing movement along a prescribed track, sequentially arranged signal paths are chronologically sequentially interrupted, distinguishes itself mainly in that a first and/or a second control signal is triggered if the chronological distance between the interruption of sequentially following signal paths exceeds a prescribed chronological distance and the gate section movement is stopped in response to the first control signal. In the case of a particularly preferred embodiment form of the invention the controller generates a second control signal in response to an interruption of at least one signal path that was not caused by the gate section movement, whereby a reversal of the gate section movement is effected in response to the second control signal.

In what follows the invention is explained in reference to the illustration to which is explicitly referred in regard to all details that are essential to the invention and are not further emphasized in the description. In the drawing are shown

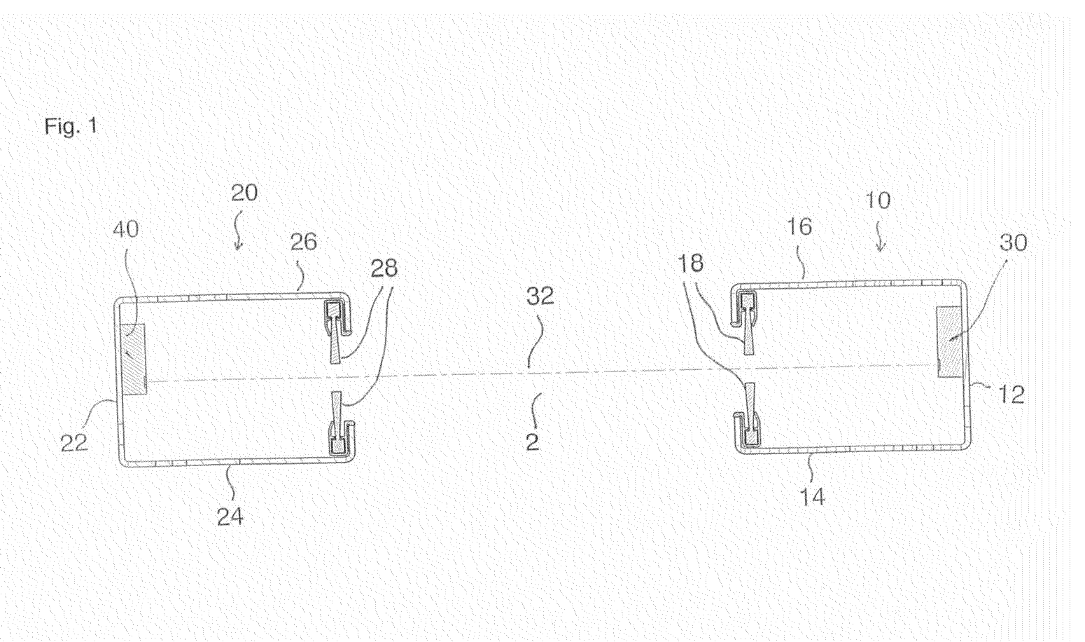

FIG. 1 a gate according to a first embodiment of the invention and

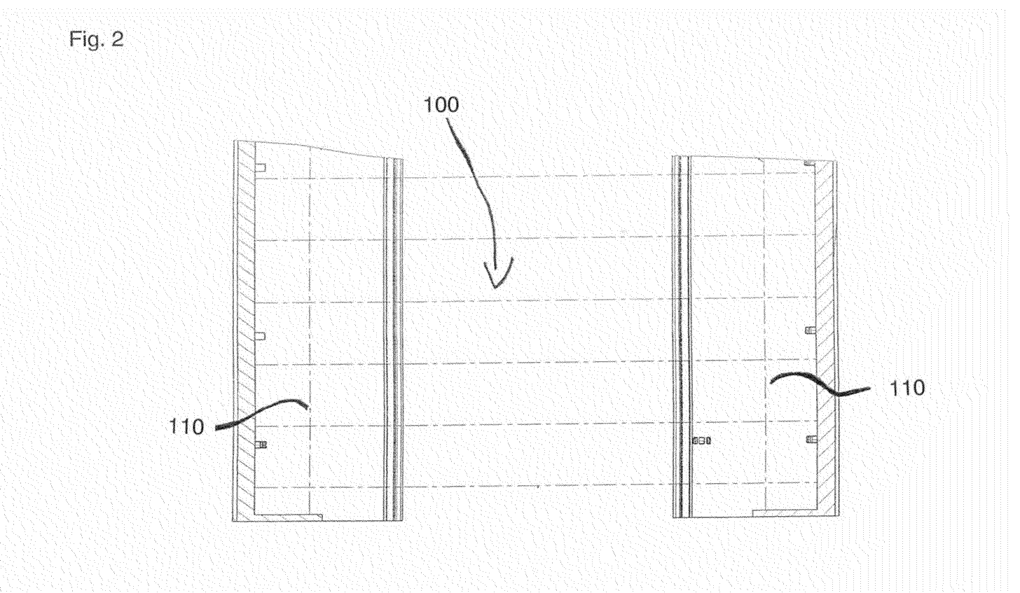

FIG. 2 a gate according to a second embodiment of the invention.

The gate represented in FIG. 1 encompasses two guiding arrangements 10, 20 for the purposes of guiding the movement of a gate section that is not represented in the illustration. Each of the guiding arrangements is implemented essentially U-shaped with a connecting leg 12, 22 and side limbs 14, 16, 24, 26 that extend from the lateral edges of the connecting leg 12, 22. Brush-shaped sealing assemblies 18, 28 that abut to the gate section in the closed position, said section being then enclosed between the side limbs 14, 16 or 24, 26, are disposed at the edges of the side limbs 14, 16 that are facing away from the connecting leg 12, 22. Attached to a boundary surface of the connecting leg 12 that is facing the opening 2 that is to be closed by means of the gate is a transmitter arrangement 30 with a plurality of light sources for the generation of light signals that spread parallel to the gate section's edge, which precedes during a closing movement, and along sequentially arranged signal paths in the direction of the prescribed path. On the other hand a receiver arrangement 40 is attached to the boundary surface, which is facing the opening 2 that is to be closed by the gate section, of the connecting leg 22 of the guiding implementation 20, said receiver attachment is for the light beams emitted by the transmitter arrangement 30.

The gate that is represented in FIG. 2 distinguishes itself from the gate explained in reference to FIG. 1 primarily in that, in addition to the light sources provided for the generation of the light gate 100, also additional light sources are provided for the generation of vertical signals 110 that spread along the prescribed track as well as corresponding sensor arrangements. The edge of the gate section, which precedes during the closing movement, is disposed between the signals 110 that spread for generation along the vertical section of the prescribed track and the corresponding receiver arrangement during trouble-free operation. If signals 110 are verified by the corresponding sensor arrangement, this can be attributed to the fact that the edge that precedes during the closing movement has exited the prescribed track. The gate is then immediately stopped.

1. Gate with a gate section that is movable, along a preferably prescribed track that features a, for the most part, rectilinear running section, between a closed position and an open position and a controller that is operable for the purposes of controlling the gate section movement and for the generation of first control signals for the purpose of stopping the gate section movement in the event of leaving the prescribed track, and is designed for the generation of second control signals, wherein in response to the second control signal a reversal of the gate section movement is triggerable, characterized in that associated with the controller is a transmitter arrangement for the purposes of generating two, three or more signals that run along approximately perpendicular to the prescribed track and approximately parallel to a, during the closing movement, preceding edge of the gate section as well as spread on sequentially arranged signal paths, in the direction of the gate section movement, whereby the signal paths during the course of the closing movement are chronologically sequentially interrupted and/or during the course of the opening movement are chronologically sequentially released, particularly by the gate section's edge that precedes during the closing movement, whereby the controller is preferably designed for the generation of the second control signals during the course of an interruption, of at least one signal path, that was not caused by the gate section movement.

2. Gate according to claim 1, characterized in that the controller features an analysis circuit for the analysis of the chronological sequence of the interruption of the signal paths during the process of the gate section closing movement or gate section opening movement and for the generation of the first and/or second control signals in the event of a deviation of the chronological sequence from a prescribed chronological sequence.

3. Gate according to claim 2, characterized in that the analysis circuit is designed for the generation of first and/or second control signals, as soon as the chronological distance between the interruption of sequentially following signal paths exceeds a prescribed chronological distance.

4. Gate according to claim 1, characterized in that the transmitter arrangement features at least one light source, such as an LED or a diode laser.

5. Gate according to claim 1, characterized by a receiver arrangement for the purpose of receiving the signals that are spreading along the signal paths, and that preferably features at least one photocell, such as for example a photodiode,

6. Gate according to claim 1, characterized in that the transmitter arrangement and/or the receiver arrangement is installed in the area of the edge of the opening that is to be closed with gate section, said edge preferably extends approximately parallel to the prescribed track, whereby the receiver arrangement is preferably installed in the area of the edge of the opening that faces the edge featuring the transmitter arrangement.

7. Gate according to claim 1, characterized in that a guide implementation is provided, preferably at least one disposed on the lateral edge of the opening to be closed with the gate section, approximately extending parallel to the prescribed track, especially in the direction of gravity, and in the closed position overlapping at least one lateral edge of the gate section in a horizontal cutting plane, for the purpose of guiding the gate movement, whereby the transmitter arrangement and/or the receiver arrangement are disposed within the guide implementation.

8. Gate according to claim 7, characterized in that at least one guiding implementation is implemented essentially U-shaped with a connecting leg, and side limbs that extend from the lateral edges of the connecting leg in the direction of the space to be closed by the gate section, whereby a lateral edge of the gate section is encompassed, in the closed position, between the side limbs.

9. Gate according to claim 8, characterized in that the transmitter arrangement and/or receiver arrangement is attached to a boundary surface, of the connecting leg, that is facing the opening.

10. Gate according to claim 1, characterized in that the gate section is windable onto a winding shaft during the course of the opening movement and preferably is implemented as a pliable track-shaped curtain.

11. Gate according to claim 10, characterized in that on the, during a closing movement, preceding edge of the track-shaped curtain a, preferably elastically deformable, stabilizing assembly is attached that counteracts the deformation of this edge.

12. Gate according to claim 11, characterized in that the reset force of the stabilizing assembly that counters the deformation in the closing direction is less than the reset force that counters a deformation in an oblique direction thereto.

13. Gate according to claim 12, characterized in that the stabilizing assembly features preferably at least one leaf spring, preferably embedded in an elastomeric material, with main surfaces aligned obliquely to the closing direction.

14. Gate according to claim 1, characterized in that associated with the controller is at least one transmitter arrangement for the purposes of generating at least one signal that is spreading along a signal path that is preferably, in the area of the guide implementation, approximately parallel to the prescribed track, whereby the signal path is interrupted by the gate section's edge, which precedes during the closing movement along the prescribed track, and the controller is operable for the purpose of the generation of first control signals in response to the release of the signal path that runs along parallel to the prescribed track.

15. Gate according to claim 1, characterized in that the controller is designed for stopping the gate section movement if a first control signal as well as a second control signal is generated.

16. Gate according to claim 1, characterized in that the first control signals can be generated in response to an activation of at least one mechanical switch, particularly a snap switch, that is attached to at least one gate section's edge that runs parallel to the prescribed track and/or in the area of a lateral edge, of the opening that is to be closed by the gate section, that extends approximately parallel to the prescribed track.

17. Process for monitoring a closing movement of a gate section of a gate, according to claim 1, along a prescribed track with said process, during the course of the closing movement along a prescribed track, sequentially arranged signal paths are chronologically sequentially interrupted, characterized in that a first and/or second control signal is triggered as soon as the chronological distance between the interruption of sequentially following signal paths exceeds a prescribed chronological distance.

18. Process according to claim 16, characterized in that the gate section movement is stopped in response to the first control signal.

19. Process according to claim 16, characterized in that a reversal of the gate section movement is effected in response to the second control signal.

20. Process according to one of the claims 16, characterized in that the gate section movement is stopped in response to a trigger of the first control signal as well as also the second control signal.
